(19) United States
(12) Patent Application Publication
(10) Pub. No.: US 2009/0251108 A1
(43) Pub. Date: Oct. 8, 2009

(54) PORTABLE ELECTRONIC DEVICE AND METHOD OF ADJUSTING CHARGING CURRENT FOR A RECHARGEABLE BATTERY UNIT THEREOF

(76) Inventors: Chun-Chen Chao, Taipei (TW); Ming-Hui Lin, Taipei (TW); Ching-Sung Chang, Taipei (TW); Yuan-Heng Huang, Taipei (TW)

Correspondence Address: CHRISTIE, PARKER & HALE, LLP, PO BOX 7068, PASADENA, CA, 91109-7068, US

(21) Appl. No.: 12/062,409

(22) Filed: Apr. 3, 2008

(51) Int. Cl. H02J 7/04; H02J 7/16

(52) U.S. Cl. 320/153; 320/150

(57) ABSTRACT

A portable electronic device includes a charging unit coupled to a rechargeable battery, an internal electronic unit, and a temperature sensor for sensing temperature of the internal electronic unit. The charging unit receives an external input power so as to output a charging current for charging the rechargeable battery, and a supply current supplied to the internal electronic unit, and adjusts the charging current outputted to the rechargeable battery unit based on the temperature of the internal electronic unit. A method of adjusting a charging current for a rechargeable battery unit of a portable electronic device is also disclosed.

### BACKGROUND OF THE INVENTION

1. Field of the Invention

The invention relates to a portable electronic device, more particularly to a portable electronic device and method of adjusting charging current for a rechargeable battery unit thereof.

2. Description of the Related Art

Referring to FIG. 1, a conventional notebook computer is shown to include a rechargeable battery unit 111, a temperature sensor 112 for sensing temperature of the rechargeable battery unit 111, and a charging unit 12 coupled to the rechargeable battery unit 111 and the temperature sensor 112, and receiving an external input power so as to output a fixed charging current for charging the rechargeable battery unit 111 until the charging unit 12 detects that the temperature of the rechargeable battery unit 111 is higher than a threshold temperature based on the output of the temperature sensor 112.

However, heat generated by the rechargeable battery unit 111 during a charging period is conducted or radiated to other electronic components of the notebook computer that are activated, thereby resulting in adverse influence on reliabilities of the other electronic components. Meanwhile, a user feels uncomfortable as a result of raised temperature of the notebook computer.

In addition, in order to improve charging efficiency, the charging current for charging the rechargeable battery unit 111 will be increased, thereby resulting in further rising of the temperature of the notebook computer. As a result, a heat-dissipating device is required for the conventional notebook computer, thereby increasing costs.

### SUMMARY OF THE INVENTION

Therefore, the object of the present invention is to provide a portable electronic device and method of adjusting a charging current for a rechargeable battery unit thereof that can overcome the aforesaid drawbacks of the prior art.

According to one aspect of the present invention, a portable electronic device comprises:

a rechargeable battery unit;

an internal electronic unit;

a first temperature sensor for sensing temperature of the internal electronic unit; and

a charging unit coupled to the rechargeable battery unit, the internal electronic unit and the first temperature sensor, and adapted to receive an external input power so as to output a charging current for charging the rechargeable battery unit, and a supply current supplied to the internal electronic unit.

The charging unit adjusts the charging current outputted to the rechargeable battery unit based on the temperature of the internal electronic unit as sensed by the first temperature sensor.

According to another aspect of the present invention, there is provided a method of adjusting a charging current for a rechargeable battery unit of a portable electronic device. The portable electronic device includes an internal electronic unit. The method comprises the steps of:

a) detecting temperature of the internal electronic unit; and

b) adjusting the charging current based on result of detection in step a).

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram illustrating a conventional notebook computer;

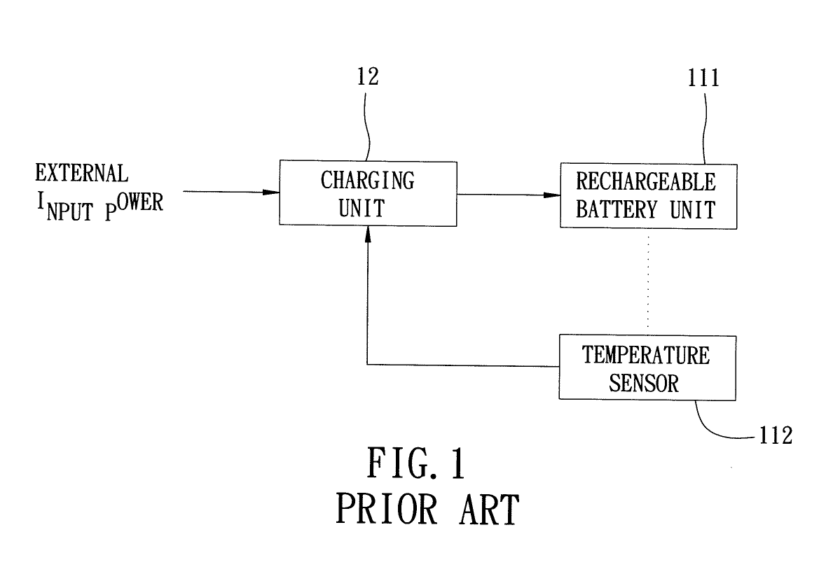

FIG. 2 is a schematic circuit block diagram illustrating the preferred embodiment of a portable electronic device according to the present invention; and

FIG. 3 is a flow chart illustrating how the preferred embodiment adjusts a charging current for a rechargeable battery unit thereof.

### DETAILED DESCRIPTION OF THE PREFERRED EMBODIMENT

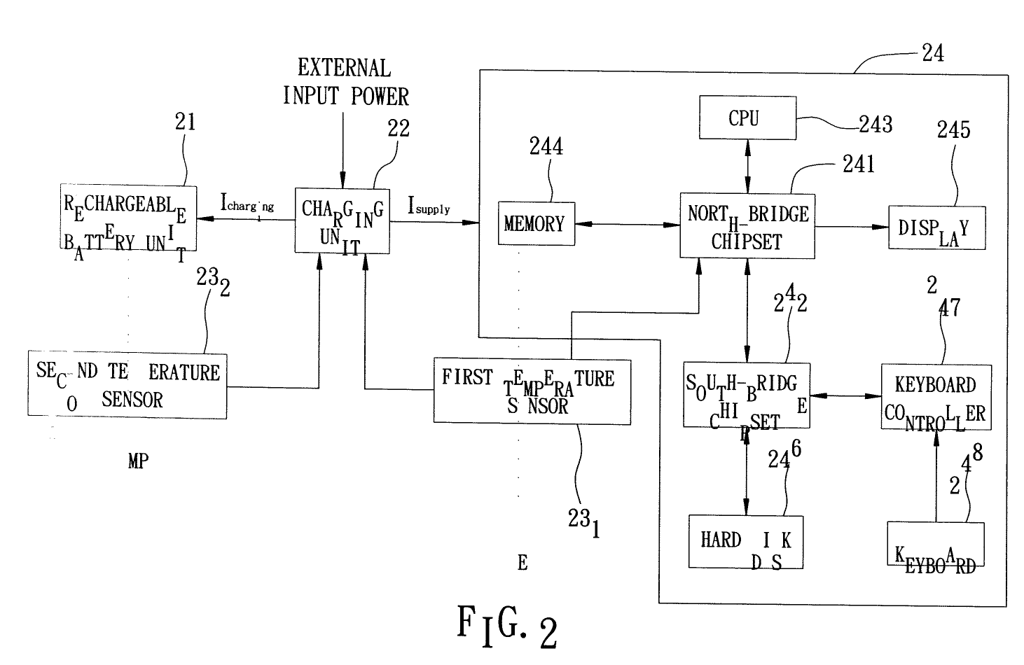

Referring to FIG. 2, the preferred embodiment of a portable electronic device according to the present invention is shown to include a rechargeable battery unit 21, an internal electronic unit 24, a first temperature sensor 231, a second temperature sensor 232, and a charging unit 22. In this embodiment, the portable electronic device is a notebook computer. In other embodiments, the portable electronic device can be a PDA, a tablet PC or a UMPC.

In this embodiment, the internal electronic unit 24 has a conventional configuration that includes a North-bridge chipset 241 coupled with a CPU 243, a memory 244 and a display 245, a South-bridge chip set 242 coupled with the North-bridge chipset 241, a keyboard controller 247 and a hard disk 246, and a keyboard 248 coupled to the keyboard controller 247. As such, details of the conventional configuration thereof are omitted for the sake of brevity.

In this embodiment, the first temperature sensor 231 is coupled to the North-bridge chipset 241 of the internal electronic unit 24 for sensing temperature (T1) of the memory 244 of the internal electronic unit 24. It is noted that the memory 244 has a duty frequency that is reduced from a predetermined frequency by the North-bridge chipset 241 upon detecting that the temperature (T1) of the memory 244 as sensed by the first temperature sensor 231 is higher than a first threshold temperature (T_{thd1}).

The second temperature sensor 232 senses temperature (T2) of the rechargeable battery unit 21.

The charging unit 22 is coupled to the rechargeable battery unit 21, the internal electronic unit 24, and the first and second temperature sensors 231, 232. The charging unit 22 is adapted to receive an external input power so as to output a charging current (I_{charging}) for charging the rechargeable battery unit 21, and a supply current (I_{supply}) supplied to the internal electronic unit 24. In this embodiment, the charging unit 22 adjusts the charging current (I_{charging}) outputted to the rechargeable battery unit 21 based on the temperatures of the memory 244 of the internal electronic unit 24 and the rechargeable battery unit 21 as sensed respectively by the first and second temperature sensors 231, 232, the supply current (I_{supply}) outputted to the internal electronic unit 24, and a current value of the charging current (I_{charging}). The charging unit 22 is operable in one of a first charging mode, where the charging current (I_{charging}) outputted to the rechargeable battery unit 21 substantially has a first predetermined current value, such as 2.5 A, a second charging mode, where the charging current (I_{charging}) outputted to the rechargeable battery unit 21 substantially has a second predetermined current value less than the first predetermined current value, such as 0.5 A, and a third charging mode, where the charging current (I_{charging}) outputted to the rechargeable battery unit 21 ranges from 0 to the first predetermined current value so that a total power consumption of the portable electronic device is not greater than a predetermined maximum power, such as 65 W.

Referring to Table 1, there are provided conditions corresponding to the first to third charging modes of the charging unit 22.

TABLE 1

| | | | | Charging |
|---|---|---|---|---|
| I_{supply} > I_{ref} | T1 > T_{thd1} | T2 > T_{thd2} | I_{charging} < 0.5 A | mode |
| NO | NO | NO | don't care | first |
| NO | YES | NO | don't care | second |
| | NO | YES | | |
| | YES | YES | | |
| YES | NO | NO | don't care | third |
| | YES | NO | NO | second |
| | NO | YES | | |
| | YES | YES | | |
| | YES | NO | YES | third |
| | NO | YES | | |
| | YES | YES | | |

The following are detailed descriptions of the conditions corresponding to the first to third charging modes of the charging unit 22.

The charging unit 22 is operated in the first charging mode upon detecting that the supply current (I_{supply}) outputted to the internal electronic unit 24 is not greater than a reference current (I_{ref}) and that the temperatures (T1, T2) of the memory 244 and the rechargeable battery unit 21 sensed respectively by the first and second temperature sensors 231, 232 are not higher than the first threshold temperature (T_{thd1}) and a second threshold temperature (T_{thd2}), respectively.

The charging unit 22 is operated in the second charging mode upon detecting that the supply current (I_{supply}) outputted to the internal electronic unit 24 is not greater than the reference current (I_{ref}) and that at least one of the temperatures (T1, T2) of the memory 244 and the rechargeable battery unit 21 is higher than a corresponding one of the first and second threshold temperatures (T_{thd1}, T_{thd2}).

The charging unit 22 is operated in the third charging mode upon detecting the supply current (I_{supply}) outputted to the internal electronic unit 24 is greater than the reference current (I_{ref}) and that the temperatures (T1, T2) of the memory 244 and the rechargeable battery unit 21 sensed respectively by the first and second temperature sensors 231, 232 are not higher than the first and second threshold temperatures (T_{thd1}, T_{thd2}) respectively.

The charging unit 22 is also operated in the second charging mode upon detecting that the supply current (I_{supply}) outputted to the internal electronic unit 24 is greater than the reference current (I_{ref}), that at least one of the temperatures (T1, T2) of the memory 244 and the rechargeable battery unit 21 is higher than the corresponding one of the first and second threshold temperatures (T_{thd1}, T_{thd2}), and that the current value of the charging current (I_{charging}) is not less than a reference current value, such as 0.5 A. In this embodiment, the reference current value is equal to the second predetermined current value.

The charging unit 22 is also operated in the third charging mode upon detecting that the supply current (I_{supply}) outputted to the internal electronic unit 24 is greater than the reference current (I_{ref}), that at least one of the temperatures (T1, T2) of the memory 244 and the rechargeable battery unit 21 is higher than the corresponding one of the first and second threshold temperatures (T_{thd1}, T_{thd2}), and that the current value of the charging current (I_{charging}) is less than the reference current value.

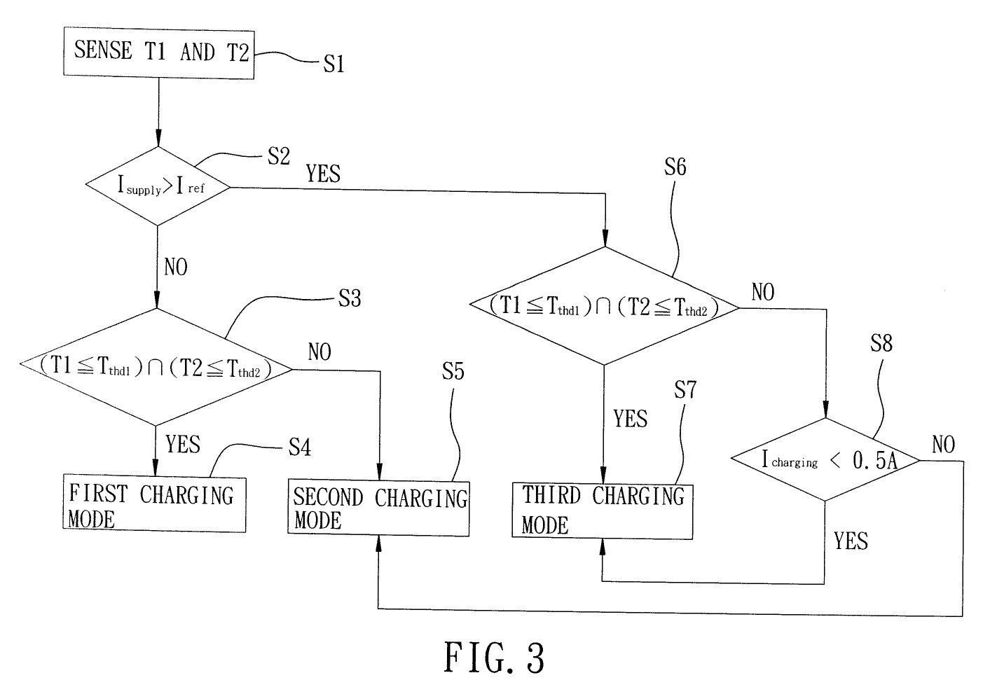

Referring to FIG. 3, there is shown a flow chart to illustrate how the charging unit 22 adjusts the charging current (I_{charging}) according to the preferred embodiment.

In step S1, the first and second temperature sensors 231, 232 sense respectively the temperatures (T1, T2) of the memory 244 and the rechargeable battery unit 21.

In step S2, the charging unit 22 detects whether the supply current (I_{supply}) outputted to the internal electronic unit 24 is greater than the reference current (I_{ref}). If negative, the flow goes to step S3. Otherwise, the flow proceeds to step S6.

In step S3, the charging unit 22 detects whether the temperature (T1) of the memory 244 as sensed by the first temperature sensor 231 is not greater than the first threshold temperature (T_{thd1}) while the temperature (T2) of the rechargeable battery unit 21 as sensed by the second temperature sensor 232 is not greater than the second threshold temperature (T_{thd2}). If affirmative, the flow goes to step S4. Otherwise, the flow proceeds to step S5.

In step S4, the charging unit 22 is operated in the first charging mode.

In step S5, the charging unit 22 is operated in the second charging mode.

In step S6, similar to step S3, the charging unit 22 detects whether the temperature (T1) of the memory 244 as sensed by the first temperature sensor 231 is not greater than the first threshold temperature (T_{thd1}) while the temperature (T2) of the rechargeable battery unit 21 as sensed by the second temperature sensor 232 is not greater than the second threshold temperature (T_{thd2}). If affirmative, the flow goes to step S7. Otherwise, the flow proceeds to step S8.

In step S7, the charging unit 22 is operated in the third charging mode.

In step S8, the charging unit 22 detects whether the current value of the charging current (I_{charging}) is less than 0.5 A, i.e., the reference current value. If affirmative, the flow goes back to step S7. Otherwise, the flow goes back to step S5.

In sum, once the temperature (T1) of the memory 244 rises to the first threshold temperature (T_{thd1}), the charging current (I_{charging}) is reduced, thereby reducing influence on the memory 244 by the heat generated by the rechargeable battery unit 21. Furthermore, when the temperature (T1) of the memory 244 is higher than the first threshold temperature (T_{thd1}), the duty frequency of the memory 244 is reduced, thereby mitigating rising of the temperature (T1) of the memory 244. As a result, the reliability of the memory 244 can be assured without the need for an additional heat-dissipating device.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A portable electronic device comprising:
a rechargeable battery unit;
an internal electronic unit;
a first temperature sensor for sensing temperature of said internal electronic unit; and
a charging unit coupled to said rechargeable battery unit, said internal electronic unit and said first temperature sensor, and adapted to receive an external input power so as to output a charging current for charging said rechargeable battery unit, and a supply current supplied to said internal electronic unit;
wherein said charging unit adjusts the charging current outputted to said rechargeable battery unit based on the temperature of said internal electronic unit as sensed by said first temperature sensor.

2. The portable electronic device as claimed in claim 1, wherein said charging unit reduces the charging current outputted to said rechargeable battery unit upon detecting that the temperature of said internal electronic unit is higher than a threshold temperature.

3. The portable electronic device as claimed in claim 2, wherein said internal electronic unit includes a memory having a duty frequency that is reduced from a predetermined frequency when the temperature thereof is higher than the threshold temperature.

4. The portable electronic device as claimed in claim 1, wherein said charging unit adjusts the charging current outputted to said rechargeable battery unit further based on the supply current outputted to said internal electronic unit.

5. The portable electronic device as claimed in claim 4, further comprising a second temperature sensor coupled to said charging unit for sensing temperature of said rechargeable battery unit,
wherein said charging unit adjusts the charging current outputted to said rechargeable battery unit further based on the temperature of said rechargeable battery unit as sensed by said second temperature sensor.

6. The portable electronic device as claimed in claim 5, wherein said charging unit reduces the charging current outputted to said rechargeable battery unit upon detecting that the supply current outputted to said internal electronic unit is not greater than a reference current and that at least one of the temperatures of said internal electronic unit and said rechargeable battery unit is higher than a corresponding one of first and second threshold temperatures.

7. The portable electronic device as claimed in claim 6, wherein said charging unit is operable in one of a first charging mode, where the charging current outputted to said rechargeable battery unit substantially has a first predetermined current value, a second charging mode, where the charging current outputted to said rechargeable battery unit substantially has a second predetermined current value less than the first predetermined current value, and a third charging mode, where the charging current outputted to said rechargeable battery unit ranges from 0 to the first predetermined current value so that a total power consumption of said portable electronic device is not greater than a predetermined maximum power.

8. The portable electronic device as claimed in claim 7, wherein:
said charging unit is operated in the first charging mode upon detecting that the supply current outputted to said internal electronic unit is not greater than the reference current and that the temperatures of said internal electronic unit and said rechargeable battery unit sensed respectively by said first and second temperature sensors are not higher than the first and second threshold temperatures, respectively;
said charging unit is operated in the second charging mode upon detecting that the supply current outputted to said internal electronic unit is not greater than the reference current and that at least one of the temperatures of said internal electronic unit and said rechargeable battery unit is higher than the corresponding one of the first and second threshold temperatures; and
said charging unit is operated in the third charging mode upon detecting that the supply current outputted to said internal electronic unit is greater than the reference current and that the temperatures of said internal electronic unit and said rechargeable battery unit sensed respectively by said first and second temperature sensors are not higher than the first and second threshold temperatures, respectively.

9. The portable electronic device as claimed in claim 7, wherein said charging unit adjusts the charging current outputted to said rechargeable battery unit further based on a current value thereof.

10. The portable electronic device as claimed in claim 9, wherein:
said charging unit is operated in the second charging mode upon detecting that the supply current outputted to said internal electronic unit is greater than the reference current, that the current value of the charging current is not less than a reference current value, and that at least one of the temperatures of said internal electronic unit and said rechargeable battery unit sensed respectively by said first and second temperature sensors is higher than the corresponding one of the first and second threshold temperatures; and
said charging unit is operated in the third charging mode upon detecting that the supply current is greater than the reference current, that the current value of the charging current is less than the reference current value, and that at least one of the temperatures of said internal electronic unit and said rechargeable battery unit sensed respectively by said first and second temperature sensor is higher than the corresponding one of the first and second threshold temperatures.

11. A method of adjusting a charging current for a rechargeable battery unit of a portable electronic device, the portable electronic device including an internal electronic unit, said method comprising the steps of:
a) detecting temperature of the internal electronic unit; and
b) adjusting the charging current based on result of detection in step a).

12. The method as claimed in claim 11, wherein, in step b), the charging current is reduced when the temperature of the internal electronic unit as detected in step a) is higher than a threshold temperature.

13. The method as claimed in claim 11, further comprising, prior to step b), a step of:
a-1) detecting a supply current supplied to the internal electronic unit;
wherein, in step b), the charging current is adjusted further based on result of detection in step a-1).

14. The method as claimed in claim 13, further comprising, prior to step b), a step of:
a-2) detecting temperature of the rechargeable battery unit;
wherein, in step b), the charging current is adjusted further based on result of detection in step a-2).

15. The method as claimed in claim 14, wherein the charging current is reduced in step b) when the supply current detected in step a-1) is not greater than a reference current, and when at least one of the temperature of the internal electronic unit detected in step a) and the temperature of the rechargeable battery unit detected in step a-2) is higher than a corresponding one of first and second threshold temperatures.

16. The method as claimed in claim 15, wherein, in step b), the charging current is adjusted to one of a first state, where the charging current substantially has a first predetermined current value, a second state, where the charging current substantially has a second predetermined current value less than the first predetermined current value, and a third state, where the charging current ranges from 0 to the first predetermined current value so that a total power consumption of the portable electronic device is not greater than a predetermined maximum power.

17. The method as claimed in claim 16, wherein, in step b):
the charging current is adjusted to the first state when the supply current detected in step a-1) is not greater than the reference current, when the temperature of the internal electronic unit detected in step a) is not higher than the first threshold temperature, and when the temperature of the rechargeable battery unit detected in step a-2) is not higher than the second threshold temperature;
the charging current is adjusted to the second state when the supply current detected in step a-1) is not greater than the reference current, and when at least one of the temperature of the internal electronic unit detected in step a) and the temperature of the rechargeable battery unit detected in step a-2) is higher than the corresponding one of first and second threshold temperatures; and
the charging current is adjusted to the third state when the supply current detected in step a-1) is greater than the reference current, when the temperature of the internal electronic unit detected in step a) is not higher than the first threshold temperature, and when the temperature of the rechargeable battery unit detected in step a-2) is not higher than the second threshold temperature.

18. The method as claimed in claim 16, wherein, in step b), the charging current is adjusted further based on a current value thereof.

19. The method as claimed in claim 18, wherein, in step b):
the charging current is adjusted to the second state when the supply current detected in step a-1) is greater than the reference current, when the current value of the charging current is not less than a reference current value, and when at least one of the temperature of the internal electronic unit detected in step a) and the temperature of the rechargeable battery unit detected in step a-2) is higher than the corresponding one of the first and second threshold temperatures; and
the charging current is adjusted to the third state when the supply current detected in step a-1) is greater than the reference current, when the current value of the charging current is less than the reference current value, and when at least one of the temperature of the internal electronic unit detected in step a) and the temperature of the rechargeable battery unit detected in step a-2) is higher than the corresponding one of the first and second threshold temperatures.
